(19) United States
(12) Patent Application Publication
(10) Pub. No.: US 2016/0253705 A1
(43) Pub. Date: Sep. 1, 2016

(54) MARKETING SYSTEM USING MOBILE DEVICE AND METHOD THEREFOR

(71) Applicant: Yedream TPS Co., LTD, Seoul (KR)

(72) Inventor: Jae Eok EOM, Seoul (KR)

(73) Assignee: Yedream TPS Co., LTD, Seoul (KR)

(21) Appl. No.: 14/400,881

(22) PCT Filed: Sep. 6, 2013
(86) PCT No.: PCT/KR2013/008059

§ 371 Date: Nov. 13, 2014

(51) Int. Cl. G06Q 30/02

(52) U.S. Cl. CPC G06Q 30/0261; G06Q 30/0267; G06Q 30/0256

(57) ABSTRACT

An advertisement system using a mobile device and a method thereof, and more specifically, an advertisement system using a mobile device and a method thereof are disclosed. If the advertisement system receives a request for information on an enterprise or a business holder which provides goods or services that a customer desires to purchase from an advertisement target customer through the mobile device and provides information on companies or business holders providing corresponding goods or services according to the position of the customer and the customer selects a specific enterprise or business holder based on the provided information, the advertisement system connects the mobile homepage of the selected enterprise or business holder to the customer, so that the customer may conveniently grasp information on an enterprise or a business holder desired by the customer while minimizing the risk of exposing personal information of the customer.

### TECHNICAL FIELD

The present invention relates to an advertisement system using a mobile device and a method thereof, and more specifically, to an advertisement system using a mobile device and a method thereof, in which if the advertisement system receives a request for information on an enterprise or a business holder which provides goods or services that a customer desires to purchase from an advertisement target customer through the mobile device and provides information on companies or business holders providing corresponding goods or services according to the position of the customer and the customer selects a specific enterprise or business holder based on the provided information, the advertisement system connects the mobile homepage of the selected enterprise or business holder to the customer, so that the customer may conveniently grasp information on an enterprise or a business holder desired by the customer while minimizing the risk of exposing personal information of the customer, and the enterprise or the business holder may maximize advertisement effect and customer management effect by advertising the enterprise targeting only the customers who actually have an intention of purchase.

### BACKGROUND ART

One of marketing techniques of an enterprise for advertising goods or services of the enterprise is telemarketing (TM), and the telemarketing is still utilized as a popular marketing strategy despite advancement of information communication techniques such as the Internet or the like.

The telemarketing is carried out by attempting a phone call or transmitting a short message service (SMS) message or a Multimedia Message Service (MMS) message to a landline or cellular phone of a potential customer, and probability of the telemarketing leading to an actual purchase of a product is quite low when the potential customer is randomly selected.

That is, when a phone call is attempted, the success rate of the phone call is low, and although the phone call is succeeded, the potential customer is likely to disconnect the phone call at the moment of recognizing it as a promotion call.

Furthermore, since a large amount of personal information on the potential customer should be obtained to attempt a phone call to the potential customer, a large number of problems related to protection of the personal information occur.

A so-called reverse auction service has been proposed as one of attempts for solving the problems, and this refers to a service in which when a customer expresses an intention of purchasing a specific product or service, an enterprise which provides the corresponding product or service provides the customer with information related to purchase, and the customer may select an enterprise to purchase the product or service based on the provided purchase-related information.

For example, Korean Laid-opened Patent No. 10-2001-0007917 entitled “Reverse auction online and offline service system for domestic and overseas moving using Internet” is configured to include a quote request input step, a member company joining step, a reverse auction participating step, an auction processing result confirmation step, a successful bidder company notification step, and a reverse auction finishing step.

However, Korean Laid-opened Patent No. 10-2001-0007917 is merely a technique of implementing a reverse auction service as a service on the Internet and is far from a technique capable of linking an advertisement to a mobile homepage that can be connected from a mobile device rapidly advanced in recent days, maximizing advertisement effect by linking location information search in order to maximize the advertisement effect, or maximizing customer management effect.

### DISCLOSURE OF INVENTION

### Technical Problem

Therefore, the present invention has been made in view of the above problems, and it is an object of the present invention to provide an advertisement system using a mobile device and a method thereof, in which if the advertisement system receives a request for information on an enterprise or a business holder which provides goods or services that a customer desires to purchase from an advertisement target customer through the mobile device and provides information on companies or business holders providing corresponding goods or services and the customer selects a specific enterprise or business holder based on the provided information, the advertisement system connects the selected enterprise or business holder to the customer, so that the customer may conveniently grasp information on an enterprise or a business holder desired by the customer while minimizing the risk of exposing personal information of the customer, and the enterprise or the business holder may maximize advertisement effect and customer management effect by advertising the enterprise targeting only the customers who actually have an intention of purchase.

Another object of the present invention is to assign a mobile homepage to each enterprise or business holder which provides goods or services that a customer desires to purchase and, when the customer selects a specific enterprise or business holder and information on the selected enterprise or business holder is provided, provide a corresponding mobile homepage and induce continuous communication with the customer by managing the customer on the corresponding mobile homepage to maximize customer management effect.

Still another object of the present invention is to preferentially provide information on an enterprise or an enterprise member terminal close to a position of a customer in providing the customer with a mobile homepage of a specific enterprise or business holder, so that the customer is allowed to conveniently grasp an enterprise or a business holder in the neighborhood or directly contact with an individual business holder, a salesperson or the like.

### Technical Solution

To accomplish the above objects, according to one aspect of the present invention, there is provided an advertisement system using a mobile device, the system including: an enterprise member terminal for transmitting enterprise information to an advertisement server, receiving an enterprise search request from advertisement server, transmitting an enterprise advertisement request to the advertisement server, receiving an enterprise selection request from the advertisement server, and receiving information related to mobile homepage connection and information on a new bulletin board comment from the advertisement server; the advertisement server for receiving information related to mobile homepage creation from the enterprise member terminal and creating a mobile homepage and a Quick Reference (QR) code, transmitting the information related to mobile homepage connection and the information on a new bulletin board comment to the enterprise member terminal, receiving the enterprise search request from a user terminal and transmitting the received enterprise search request to the enterprise member terminal, receiving the enterprise advertisement request from the enterprise member terminal and transmitting the received enterprise advertisement request to the user terminal, receiving the enterprise selection request from the user terminal and transmitting the received enterprise selection request to the enterprise member terminal, searching for location information of the enterprise member terminal based on a position of the user terminal, and providing the user terminal with mobile homepage information related to a selected enterprise; and the user terminal for transmitting the enterprise search request to the advertisement server through a mobile search web page provided by the advertisement server, receiving the enterprise advertisement request from the advertisement server, transmitting the enterprise selection request to the advertisement server, and receiving the mobile homepage information related to the selected enterprise from the advertisement server.

At this point, the advertisement server includes a function of receiving service evaluation information related to a mobile homepage of a specific enterprise member from the user terminal and providing the received service evaluation information to the user terminal by displaying on a corresponding mobile homepage.

In addition, at this point, the advertisement server includes a function of transmitting a link request to an SNS server when an SNS link request is received from the enterprise member terminal for the information on a new bulletin board comment of a specific mobile homepage.

According to another aspect of the present invention, there is provided an advertisement method using a mobile device, the method including the steps of: (A) receiving information related to mobile homepage creation from an enterprise member terminal and creating a mobile homepage, by an advertisement server; (B) displaying a mobile search web page on a user terminal, receiving an enterprise search request from the user terminal by selection of a specific search keyword or category, and transmitting the received enterprise search request to the enterprise member terminal, by the advertisement server; (c) receiving an enterprise advertisement request from the enterprise member terminal, transmitting the received enterprise advertisement request to the user terminal, and searching for location information of the enterprise member terminal based on a position of the user terminal, by the advertisement server; and (D) receiving an enterprise selection request from the user terminal, transmitting the received enterprise selection request to the enterprise member terminal, and providing the user terminal with a mobile homepage related to the enterprise member terminal, by the advertisement server.

At this point, the advertisement method further includes, after step (D), the steps of: (E) notifying information related to mobile homepage connection and information on a new bulletin board comment to the enterprise member terminal by means of a guide message, by the advertisement server; (F) notifying information on mileage awarded to the user terminal based on predetermined criteria to the user terminal by means of a guide message, by the advertisement server; and (G) transmitting a link request to an SNS server, by the advertisement server, when an SNS link request is received from the enterprise member terminal for the information on a new bulletin board comment of the mobile homepage.

### Advantageous Effects

According to the present invention, if the advertisement system receives a request for information on an enterprise or a business holder which provides goods or services that a customer desires to purchase from an advertisement target customer through the mobile device and provides information on companies or business holders providing corresponding goods or services and the customer selects a specific enterprise or business holder based on the provided information, the advertisement system connects the selected enterprise or business holder to the customer, so that the customer may conveniently grasp information on an enterprise or a business holder desired by the customer while minimizing the risk of exposing personal information of the customer, and the enterprise or the business holder may maximize advertisement effect and customer management effect by advertising the enterprise targeting only the customers who actually have an intention of purchase.

According to the present invention, a mobile homepage is assigned to each enterprise or business holder which provides goods or services that a customer desires to purchase, and, when the customer selects a specific enterprise or business holder and information on the selected enterprise or business holder is provided, a corresponding mobile homepage is provided, and continuous communication with the customer is induced by managing the customer on the corresponding mobile homepage to maximize customer management effect.

According to the present invention, information on an enterprise or an enterprise member terminal close to a position of a customer is preferentially provided in providing the customer with a mobile homepage of a specific enterprise or business holder, so that the customer is allowed to conveniently grasp an enterprise or a business holder in the neighborhood or directly contact with an individual business holder, a salesperson or the like.

### BRIEF DESCRIPTION OF THE DRAWINGS

FIG. 1 is a view showing the entire configuration of an advertisement system using a mobile device according to a preferred embodiment of the present invention.

FIG. 2 is a view showing a detailed configuration of a homepage management means of an advertisement server according to a preferred embodiment of the present invention.

FIG. 3 is a view showing a detailed configuration of an advertisement management means of an advertisement server according to a preferred embodiment of the present invention.

FIG. 4 is an overall flowchart illustrating an advertisement method using a mobile device according to a preferred embodiment of the present invention.

### DESCRIPTION OF SYMBOLS

100: Enterprise member terminal
200: Advertisement server
210: Homepage management means
211: Homepage information receiving means
212: Homepage creation means
213: Notification means
214: Linking means
215: Mileage management means
220: Advertisement management means
221: Enterprise information management means
222: Search request management means
223: Advertisement request management means
224: Selection request management means
225: Location information management means
230: Member management means
240: Database
300: User terminal
400: SNS server

### BEST MODE FOR CARRYING OUT THE INVENTION

Preferred embodiments of the present invention will be described hereinafter in detail with reference to the accompanying drawings. Prior to the description, the terms or words used in the specification and the claims are not limited to or should not be construed as being typical or dictionary meanings, but should be construed as meanings and concepts which conform with the technical spirit of the present invention based on the principle that an inventor may properly define the concepts of the terms in order to describe his invention using the best method.

In the following description, the detailed description on known function and constructions unnecessarily obscuring the subject matter of the present invention will be avoided hereinafter.

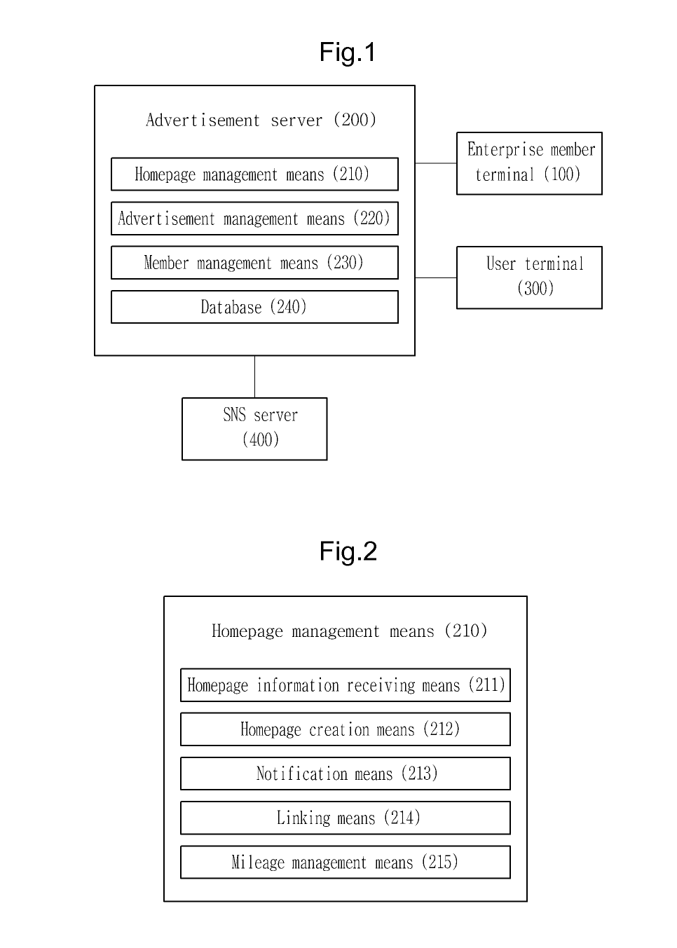

Hereafter, an advertisement system using a mobile device according to a preferred embodiment of the present invention will be described in detail with reference to FIGS. 1 to 3.

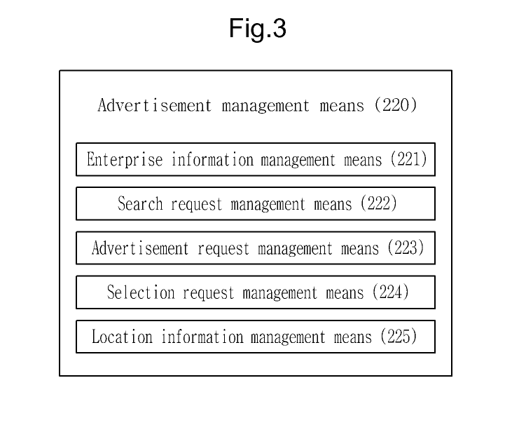

FIG. 1 is a view showing the entire configuration of an advertisement system using a mobile device according to a preferred embodiment of the present invention, FIG. 2 is a view showing a detailed configuration of a homepage management means of an advertisement server according to a preferred embodiment of the present invention, and FIG. 3 is a view showing a detailed configuration of an advertisement management means of an advertisement server according to a preferred embodiment of the present invention.

As shown in FIG. 1, an advertisement system using a mobile device according to a preferred embodiment of the present invention includes an enterprise member terminal 100, an advertisement server 200, a user terminal 300 and an SNS server 400.

First, the enterprise member terminal 100 is a terminal of an enterprise member (an enterprise or an individual business holder) who desires to use an advertisement service provided according to a preferred embodiment of the present invention, and the enterprise member terminal 100 transmits information on the enterprise to the advertisement server 200, receives an enterprise search request from the advertisement server 200, transmits an enterprise advertisement request to the advertisement server 200, and receives an enterprise selection request from the advertisement server 200.

In addition, the enterprise member terminal 100 transmits information related to mobile homepage creation to the advertisement server 200 and receives Quick Response (QR) information, information related to mobile homepage connection and information on a new bulletin board comment from the advertisement server 200.

Although it is assumed that the enterprise member terminal 100 is a personal computer (PC) or a terminal such as a smart phone or the like, preferably a smart phone, for convenience in a preferred embodiment of the present invention, the enterprise member terminal 100 may be a server managed by an enterprise member and construct a customer management database containing information on management target customers managed by the enterprise member.

Meanwhile, the enterprise member terminal 100 includes a GNSS receiver for location information management described below, and the GNSS receiver derives coordinates of a position of a separate navigation satellite based on the information on the satellite trajectory (ephemeris) received after connecting to the satellite through a wired or wireless Internet network and derives coordinates of a position of a user based on the derived coordinates of the position of the satellite.

The type of the enterprise member is not specially limited, and, particularly, it may be an insurance company, a security company or the like for which a reverse auction advertisement may exhibit outstanding advertisement effect, or it may be a variety of business types, for example, a business holder running a self-employed small business such as a restaurant, a retail store or the like in a community.

Specifically, the enterprise member terminal 100 transmits information on an enterprise to the advertisement server 200 and transmits an enterprise advertisement request upon receiving an enterprise search request from the advertisement server 200, and, for example, if the enterprise member is an insurance company, information on the enterprise transmitted to advertisement server 200 by the enterprise member may include a company name, a business type, major products, locations of the headquarter and branches and the like.

In addition, the enterprise advertisement request transmitted to the advertisement server 200 by the enterprise member, which is an insurance company, may include information on an insurance quote including important insured items, premiums and the like of each insurance product.

In addition, the advertisement server 200 is a server of a person operating an advertisement service according to a preferred embodiment of the present invention and includes a homepage management means 210, an advertisement management means 220, a member management means 230 and a database 240.

First, the homepage management means 210 creates and manages a mobile homepage assigned to the enterprise member terminal 100 by the advertisement server 200 and includes a homepage information receiving means 211, a homepage creation means 212, a notification means 213, a linking means 214 and a mileage management means 215 as shown in FIG. 2.

The homepage information receiving means 211 receives the information related to mobile homepage creation from the enterprise member terminal 100 so that the information may be used for creating a mobile homepage.

The information related to mobile homepage creation may include enterprise member information, skin information (a basic template of a mobile web), product or service information, bulletin board information and the like.

On the other hand, although it is assumed that the information related to mobile homepage creation is received from the enterprise member terminal 100 in a preferred embodiment of the present invention, the present invention is not limited to this, and the homepage information receiving means 211 may use information related to mobile homepage creation previously set for each enterprise member or collectively set for enterprise members.

The homepage creation means 212 creates a mobile homepage of a specific enterprise member based on the information related to mobile homepage creation and creates a Quick Response (QR) code.

Accordingly, the enterprise member may conveniently advertise goods and services of the enterprise at a low price through the mobile homepage provided by the advertisement server 200 and absorb various potential customers by advertising the mobile homepage address or the QR code through various kinds of printed materials, catalogs or the like, as well as online media, and a user using the advertisement service according to a preferred embodiment of the present invention may conveniently acquire various kinds of information for selecting an enterprise only by connecting to the mobile homepage of each enterprise member.

The notification means 213 periodically or randomly transmits the information related to mobile homepage connection to the enterprise member terminal 100 and particularly notifies information on a new bulletin board comment to the enterprise member terminal 100 by means of a guide message.

At this point, a type of the guide message may be Short Message Service (SMS), Multimedia Message Service (MMS), Long Message Service (LMS), URL-SMS, a push notification or the like, and, hereinafter, this is a case referred to as a “guide message”.

Particularly, URL-SMS information is information of a method combining an SMS and wireless Internet information of a portable terminal, which means a guide message transmitted together with a WAP page so as to conveniently connect to the wireless Internet.

Of course, in the present invention, it is apparent that types of the guide message are not limited to the types described above, and it may be set in any method capable of providing predetermined information.

The information related to the mobile homepage connection may be information on the number of visitors, the number of re-visitors, a connection time, a most frequently connected page and the like, and the enterprise member may maintain optimum customer management even after goods or services are purchased in an reverse auction method based on the information related to the mobile homepage connection.

Purchase, inquiry of use, an order, a pre-order or the like of goods, events, contents or the like is made on the bulletin board of the mobile homepage, and when a new comment such as a posting, a comment, a request for an order, a request for a pre-order, a request for a phone call or the like is registered by the user terminal 300, this new comment is notified to the enterprise member terminal 100 in real-time so that the enterprise member may promptly process the work.

The linking means 214 may register information on a new bulletin board comment of a mobile homepage, particularly, information on an information bulletin board comment, in the SNS account of the enterprise member terminal 100 by transmitting a link request for the information on the new bulletin board comment to the SNS server 400.

The bulletin board of the mobile homepage is largely configured of a service bulletin board and an information bulletin board, and it may be understood that the service bulletin board is a bulletin board for registering comments related to inquiry of purchase or use, order, pre-order of goods, events, contents or the like and the information bulletin board is a bulletin board for registering promotion data for various goods, events, contents or the like and comments on other additional data or the like.

Owing to the SNS link of the enterprise member terminal 100, the user may conveniently confirm various data introduced or advertised by the enterprise member in real-time on the SNS service and use the data as a reference data for selecting a service of the enterprise member in the future.

In addition, when an SNS link request for the information on a new bulletin board comment of the mobile homepage is received from the user terminal 300, the linking means 214 may register the information on an information bulletin board comment in the SNS account of the user by transmitting a link request to the SNS server 400.

The mileage management means 215 awards mileage to the user terminal 300 based on predetermined criteria and periodically or randomly, preferably at the time point of awarding the mileage, transmits information on the awarded mileage to the user terminal 300 in the form of a guide message.

For example, the mileage management means 215 may accumulate and notify the mileage in such a manner that one thousand points when the user terminal 300 connects to a specific mobile homepage, two thousand points when a new comment is registered on the bulletin board of the mobile homepage by the user terminal 300, five thousand points when the mileage is requested to be used from the user terminal 300 through a request for purchasing a product or an actual visit to a store, and two thousand points when service evaluation information related to a specific mobile homepage is received from the user terminal 300.

The mileage awarded by the mileage management means 215 may be awarded according to a condition previously set by an enterprise member requesting creation of a mobile homepage, and it may function as a motivation of continuously visiting the mobile homepage since the user may receive a predetermined benefit thereby.

Additionally, since the homepage management means 210 provides a function of evaluating an enterprise member, it receives service evaluation information related to a specific enterprise member or mobile homepage from the user terminal 300 and provides the information by displaying on a mobile homepage assigned to the enterprise member.

Accordingly, when other users, as well as the user who has evaluated the specific enterprise member, connect to a mobile homepage assigned to a certain enterprise member, they may select an enterprise member with reference to the evaluation information of the enterprise member.

Next, the advertisement management means 220 manages advertisements of enterprise members provided to the user terminal 300 and is configured to include an enterprise information management means 221, a search request management means 222, an advertisement request management means 223, a selection request management means 224 and a location information management means 225.

The enterprise information management means 221 receives enterprise information from the enterprise member terminal 100.

The enterprise information received by the enterprise information management means 221 functions as basic information for selecting an appropriate enterprise and connecting the selected enterprise to a user when an enterprise search request related to an enterprise which provides a product or a service desired by the user is received from the user terminal 300, and if the enterprise member is an insurance company, the enterprise information may include a company name, a business type, major products, locations of the headquarter and branches, contact information (a phone number) and the like.

The search request management means 222 receives an enterprise search request related to an enterprise which provides a product or a service desired by the user from the user terminal 300 and transmits the received enterprise search request to the enterprise member terminal 100.

Specifically, the search request management means 222 displays a mobile search web page on the user terminal 300 and receives an enterprise search request from the user terminal 300 through the mobile search web page by the selection of a specific search keyword or category.

For example, the user may connect to the mobile search web page provided by the search request management means 222 through the user terminal 300 and input a search keyword such as “Meeting place/Korean restaurant/Ten persons” or the like into a search keyword input window, or the user may search for an enterprise or a business holder desired by the user by sequentially selecting categories classified on the basis of a type, a location or a scale of the business, or these methods may be combined with each other.

If an enterprise search request is received from the user terminal 300, the search request management means 222 extracts a category (a type, a location or a scale of the business) matching to a corresponding search keyword using the input search keyword and transmits the enterprise search request to a plurality of enterprise member terminals 100 corresponding to the extracted category by means of a guide message.

At this point, it is preferable not to include a phone number or the like of the user in the enterprise search request transmitted to the enterprise member terminal 100, and in transmitting the enterprise search request to a plurality of enterprise member terminals 100, the enterprise search request may be transmitted only to a predetermined number of enterprise members in descending order of a degree of matching to the input search keyword by the degree of matching, or the enterprise search request may be transmitted only to a predetermined number of enterprise members in order of the location of the enterprise member terminal 100 close to the position of the user terminal 300 by the location, or these methods may be combined with each other.

Additionally, when a search keyword is input from the user terminal 300 through the mobile search web page, the search request management means 222 provides a list of enterprise members or mobile homepages matching to the corresponding search keyword through a search result screen of the mobile search web page, and it is preferable to provide information on the enterprise members or the mobile homepages in order of superior enterprise member evaluation information described above, and even when the user selects a specific category, it is preferable to provide information on the enterprise members or the mobile homepages in order of superior enterprise member evaluation information within a corresponding category.

The advertisement request management means 223 receives an enterprise advertisement request from the enterprise member terminal 100 and transmits the received enterprise advertisement request to the user terminal 300.

Specifically, when the enterprise member receives an enterprise search request through the enterprise member terminal 100 and desires to advertise goods or services provided by the enterprise targeting the user, the enterprise member transmits an enterprise advertisement request of his or her enterprise to the advertisement request management means 223 through the enterprise member terminal 100.

The enterprise advertisement request transmitted by the enterprise member may include a purchase price of a product or a service, specialized event information or the like so as to be configured as an offer proposed by the enterprise to the advertisement target user.

The enterprise advertisement requests received by the advertisement request management means 223 from the enterprise member terminal 100 are provided to the user terminal 300 in descending order of a degree of matching to the enterprise search request received from the user terminal 300, and the user may see the plurality of enterprise advertisement requests and select a specific enterprise.

Particularly, when the advertisement request management means 223 transmits the enterprise advertisement requests to the user terminal 300, the enterprise advertisement requests may be transmitted in order of the location of the enterprise or the enterprise member terminal 100 close to the position of the user terminal 300.

When the advertisement request management means 223 transmits the enterprise advertisement requests to the user terminal 300 based on the degree of matching or the location information, it is preferable to transmit a predetermined number of enterprise advertisement requests, for example, only five enterprise advertisement requests, and this will prevent a situation of runaway of guide messages in the user terminal 300 in relation to the enterprise advertisement requests.

If an enterprise selection request is not received from the user terminal 300 even when a specific number of enterprise advertisement requests are transmitted as described below, i.e., an enterprise desired by the user is not in the enterprise advertisement requests, the user terminal 300 may transmit an enterprise re-search request, and in this case, the advertisement request management means 223 transmits lower priority enterprise advertisement requests excluding the previously transmitted enterprise advertisement requests.

In addition, the enterprise advertisement requests transmitted to the user terminal 300 by the advertisement request management means 223 preferably have a form of a guide message, and the guide message may include the company name, location, contact information and mobile homepage URL information of the enterprise member.

The user may directly contact with the enterprise member using the contact information included in the guide message, conveniently connect to the mobile homepage of the enterprise member and acquire various kinds of information only by touching the URL of the mobile homepage, and continuously maintain a relation with the enterprise member even after purchasing a product or a service from a desired enterprise by continuously connecting to the corresponding mobile homepage.

On the other hand, if the advertisement request management means 223 does not receive an enterprise advertisement request from the enterprise member terminal 100 after the search request management means 222 transmits the enterprise search request of the user to the enterprise member terminal 100, i.e., when the enterprise member does not participate in a reverse auction for various reasons, the advertisement request management means 223 may transmit an enterprise search request of the user and an appropriate enterprise advertisement request to the user terminal 300 based on previously stored enterprise information.

The selection request management means 224 receives an enterprise selection request from the user terminal 300 and transmits the received enterprise selection request to the enterprise member terminal 100 so that actual purchase or the like may be accomplished.

Specifically, the user may confirm the received enterprise advertisement request and transmit an enterprise selection request for a desired enterprise member to the selection request management means 224, and, for example, the user may request a purchase, a pre-order, an inquiry or the like.

In addition, since the enterprise advertisement request received by the user includes the company name, location, contact information and mobile homepage URL information of the enterprise member, the user may directly make a phone call to the enterprise or an individual business holder or may connect to the mobile homepage and directly make a purchase, a pre-order or an inquiry of a product or a service on the mobile homepage.

When a user connects to a mobile homepage and purchases a product or a service as described above, purchase completion information is provided to the enterprise member by means of a guide message or a mobile homepage bulletin board, and the enterprise member may progress further procedures such as reconfirmation of purchase, guide of delivery and the like.

In a preferred embodiment of the present invention, an actual purchase procedure or the like between a user and an enterprise member is preferably performed through a mobile homepage.

It is since that the user and the enterprise member may enjoy a service of providing information related to mobile homepage connection, a service of providing information on a new bulletin board comment, an SNS link service, a mileage service and the like through the mobile homepage as described above.

When the enterprise search request is received from the user terminal 300, the location information management means 225 searches for and manages location information of an office of an enterprise member or an enterprise member terminal 100 close to the position of the user terminal 300 in real-time so as to use the location information when the advertisement request management means 223 transmits the enterprise advertisement request to the user terminal 300.

The location information management means 225 preferably searches for an office or an enterprise member terminal 100 of an enterprise member existing within a predetermined radius from the user terminal 300.

Although the location information management means 225 may employ a plurality of methods as a method of searching for location information of the enterprise member terminal 100, a method using coordinates of a position of a satellite or coordinates of a location of the enterprise member terminal 100 received from the enterprise member terminal 100 may be employed.

Next, the member management means 230 receives member information from the enterprise member terminal 100 or the user terminal 300 and performs a log-in process of the enterprise member terminal 100 or the user terminal 300 on the mobile homepage.

Finally, the database 240 stores various kinds of information and is configured to include a member information database and a homepage information database.

The member information database stores various kinds of member information of an enterprise member or a user, such as enterprise information, personal information, additional information, a member ID, a password, SNS account information and the like, and particularly stores location information of an enterprise member office, and, when related information is updated, the member information database stores the updated information.

The homepage information database stores information related to a mobile homepage, such as information related to mobile homepage creation, QR code information, information related to mobile homepage connection, information on a new bulletin board comment, mileage information of each user and the like, and when related information is updated, the homepage information database stores the updated information.

In addition, the user terminal 300 is a terminal of a user using the advertisement service according to a preferred embodiment of the present invention, which transmits an enterprise search request to the advertisement server 200 through the mobile search web page provided by the advertisement server 200, receives an enterprise advertisement request from the advertisement server 200, and transmits an enterprise selection request to the advertisement server 200 or transmits an enterprise selection request such as a purchase, a pre-order, an inquiry or the like directly to the enterprise member terminal 100.

At this point, the user terminal 300 preferably transmits and receives the enterprise search request or the enterprise advertisement request in the form of a guide message, connects to the mobile homepage of the enterprise member using mobile homepage URL information included in the enterprise advertisement request, registers a new bulletin board comment on the connected mobile homepage, registers an SNS link request, and receives information on mileage award.

Although the user terminal 300 is preferably a smart phone which can display a mobile web page, the present invention is not limited thereto.

Meanwhile, the user terminal 300 includes a GNSS receiver for location information management described above, and the GNSS receiver derives coordinates of a position of a separate navigation satellite based on the information on the satellite trajectory (ephemeris) received after connecting to the satellite through a wired or wireless Internet network and derives coordinates of a position of a user based on the derived coordinates of the position of the satellite.

In addition, the SNS server 400 is a server of a person operating a social network service, which receives a link request for information on a new bulletin board comment from the advertisement server 200 and links the new bulletin board comment to the SNS account of the enterprise member terminal 100 or the user terminal 300 so that the user may confirm the new bulletin board comment on the SNS.

A type of an SNS provided by the SNS server 400 is not specially limited, and it may be Twitter, Facebook, Me2 day or the like.

According to the present invention, a customer may conveniently grasp information on an enterprise member or an individual business holder desired by the customer while minimizing the risk of exposing personal information of the customer, and the enterprise or the business holder may maximize advertisement effect and customer management effect by advertising the enterprise or the business targeting only the customers who actually have an intention of purchase.

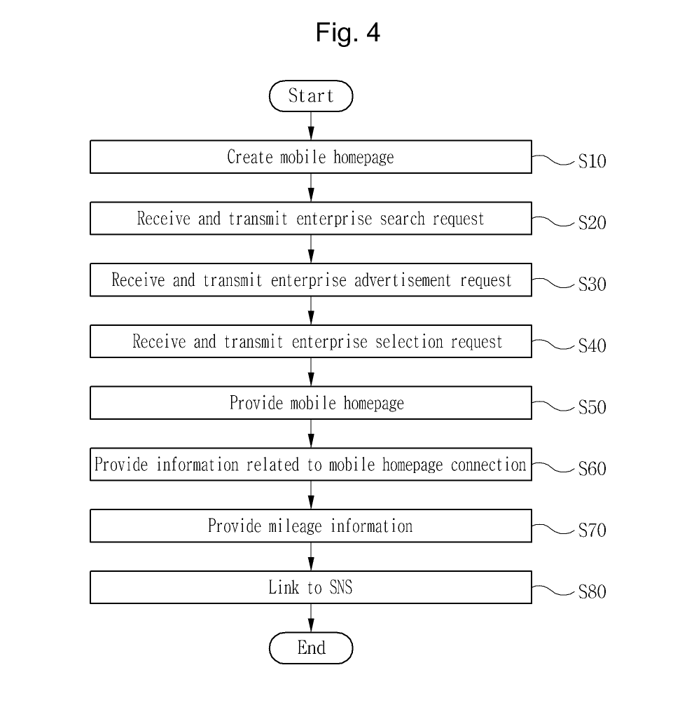

Hereinafter, an advertisement method using a mobile device according to a preferred embodiment of the present invention will be described in detail with reference to FIG. 4.

FIG. 4 is an overall flowchart illustrating an advertisement method using a mobile device according to a preferred embodiment of the present invention.

First, as shown in FIG. 4, the homepage management means 210 of the advertisement server 200 creates a mobile homepage assigned to the enterprise member terminal 100 S10.

Step S10 may include the steps of receiving information related to mobile homepage creation from the enterprise member terminal 100 by the homepage management means 210 of the advertisement server 200 and creating a mobile homepage of a specific enterprise member and a Quick Response (QR) code by the homepage creation means 212 of the advertisement server 200 based on the information related to mobile homepage creation.

At step S10, the information related to mobile homepage creation may include enterprise member information, skin information (a basic template of a mobile web), product information, bulletin board information and the like.

Next, the advertisement management means 220 of the advertisement server 200 receives enterprise information from the enterprise member terminal 100, receives an enterprise search request related to an enterprise which provides a product or a service desired by the user from the user terminal 300, and transmits the received enterprise search request to the enterprise member terminal 100 S20.

At step S20, specifically, the advertisement management means 220 of the advertisement server 200 displays a mobile search web page on the user terminal 300 and receives the enterprise search request through the mobile search web page from the user terminal 300 by the selection of a specific search keyword or category.

Next, the advertisement management means 220 of the advertisement server 200 receives an enterprise advertisement request from the enterprise member terminal 100 and transmits the received enterprise advertisement request to the user terminal 300 S30.

At step S30, the enterprise advertisement requests received by the advertisement management means 220 of the advertisement server 200 from the enterprise member terminal 100 are provided to the user terminal 300 in descending order of a degree of matching to the enterprise search request received from the user terminal 300, and the user may see the plurality of enterprise advertisement requests and select a specific enterprise.

In addition, at step S30, when the advertisement management means 220 of the advertisement server 200 transmits the enterprise advertisement requests to the user terminal 300, the enterprise advertisement requests may be transmitted in order of the location of the enterprise or the enterprise member terminal 100 close to the position of the user terminal 300.

In addition, although step S30 may include the step of searching for, by the advertisement management means 220 of the advertisement server 200, location information of an office of an enterprise member or an enterprise member terminal 100 close to the position of the user terminal 300, the present invention is not limited thereto.

Next, the advertisement management means 220 of the advertisement server 200 receives an enterprise selection request from the user terminal 300 and transmits the received enterprise selection request to the enterprise member terminal 100 S40.

Next, the homepage management means 210 of the advertisement server 200 provides the user terminal 300 with a mobile homepage assigned to the enterprise member terminal 100 S50.

Next, the homepage management means 210 of the advertisement server 200 periodically or randomly transmits information related to mobile homepage connection to the enterprise member terminal 100 and particularly notifies information on a new bulletin board comment to the enterprise member terminal 100 by means of a guide message S60.

At step S60, the information related to the mobile homepage connection may be information on the number of visitors, the number of re-visitors, a connection time, a most frequently connected page and the like.

In addition, purchase, inquiry of use, an order, a pre-order or the like of goods, events, contents or the like is made on the bulletin board of the mobile homepage, and when a new comment such as a posting, a comment, a request for an order, a request for a pre-order, a request for a phone call or the like is registered by the user terminal 300, this new comment is notified to the enterprise member terminal 100 in real-time so that the enterprise member may promptly process the work.

Next, the advertisement management means 220 of the advertisement server 200 awards mileage to the user terminal 300 based on predetermined criteria and periodically or randomly, preferably at the time point of awarding the mileage, transmits information on the awarded mileage to the user terminal 300 in the form of a guide message S70.

Finally, when an SNS link request for the information on a new bulletin board comment of the mobile homepage is received, the advertisement management means 220 of the advertisement server 200 may register the information on an information bulletin board comment in the SNS account of the user by transmitting a link request to the SNS server 400 S80.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

1. An advertisement system using a mobile device, the system comprising:
an enterprise member terminal for transmitting enterprise information to an advertisement server, receiving an enterprise search request from advertisement server, transmitting an enterprise advertisement request to the advertisement server, receiving an enterprise selection request from the advertisement server, and receiving information related to mobile homepage connection and information on a new bulletin board comment from the advertisement server;
the advertisement server for receiving information related to mobile homepage creation from the enterprise member terminal and creating a mobile homepage and a Quick Reference (QR) code, transmitting the information related to mobile homepage connection and the information on a new bulletin board comment to the enterprise member terminal, receiving the enterprise search request from a user terminal and transmitting the received enterprise search request to the enterprise member terminal, receiving the enterprise advertisement request from the enterprise member terminal and transmitting the received enterprise advertisement request to the user terminal, receiving the enterprise selection request from the user terminal and transmitting the received enterprise selection request to the enterprise member terminal, searching for location information of the enterprise member terminal based on a position of the user terminal, and providing the user terminal with mobile homepage information related to a selected enterprise; and
the user terminal for transmitting the enterprise search request to the advertisement server through a mobile search web page provided by the advertisement server, receiving the enterprise advertisement request from the advertisement server, transmitting the enterprise selection request to the advertisement server, and receiving the mobile homepage information related to the selected enterprise from the advertisement server.

2. The system according to claim 1, wherein the advertisement server includes:
a function of receiving service evaluation information related to a mobile homepage of a specific enterprise member from the user terminal and providing the received service evaluation information to the user terminal by displaying on a corresponding mobile homepage.

3. The system according to claim 1, wherein the advertisement server includes:
a function of transmitting a link request to an SNS server when an SNS link request is received from the enterprise member terminal for the information on a new bulletin board comment of a specific mobile homepage.

4. An advertisement method using a mobile device, the method comprising the steps of:
(A) receiving information related to mobile homepage creation from an enterprise member terminal and creating a mobile homepage, by an advertisement server;
(B) displaying a mobile search web page on a user terminal, receiving an enterprise search request from the user terminal by selection of a specific search keyword or category, and transmitting the received enterprise search request to the enterprise member terminal, by the advertisement server;
(c) receiving an enterprise advertisement request from the enterprise member terminal, transmitting the received enterprise advertisement request to the user terminal, and searching for location information of the enterprise member terminal based on a position of the user terminal, by the advertisement server; and
(D) receiving an enterprise selection request from the user terminal, transmitting the received enterprise selection request to the enterprise member terminal, and providing the user terminal with a mobile homepage related to the enterprise member terminal, by the advertisement server;

5. The method according to claim 4, wherein the method including the further steps of:
(E) notifying information related to mobile homepage connection and information on a new bulletin board comment to the enterprise member terminal by means of a guide message, by the advertisement server;
(F) notifying information on mileage awarded to the user terminal based on predetermined criteria to the user terminal by means of a guide message, by the advertisement server; and
(G) transmitting a link request to an SNS server, by the advertisement server, when an SNS link request is received from the enterprise member terminal for the information on a new bulletin board comment of the mobile homepage.
